(19) United States
(12) Patent Application Publication
(10) Pub. No.: US 2003/0090464 A1
(43) Pub. Date: May 15, 2003

(54) Computer mouse with a hand-protecting cover

(76) Inventors: Chao-Chi Lai, Taipei City (TW); Michael Thiel, Taipei Hsien (TW)

Correspondence Address: CHAO-CHI LAI & INTRACOM ASIA CO. LTD., P. O. Box No.6-57, Chung-Ho, Taipei, 235, TW

(21) Appl. No.: 09/986,493

(22) Filed: Nov. 9, 2001

(51) Int. Cl. G09G 5/08

(52) U.S. Cl. 345/163

(57) ABSTRACT

The present invention is of a computer mouse with a hand-protecting cover; the surface of the mouse is affixed by a layer of antibacterial, mildew-resistant and soft foam rubber skin manufactured according to various external shapes of the mice; the layer is adhered to the upper surface layer or the lateral surface layer also of the mouse in the manner of forceful affixation or a simple peelable and replaceable method; the color of the foam rubber skin can be multiple so as to achieve the function of being innovative, aesthetic, comfortable, anti-dust and antistatic.

### BACKGROUND OF THE INVENTION

1) Field of the Invention

The present invention relates to a computer mouse with a hand-protecting cover; more particularly to the surface of the mouse is affixed by a layer of antibacterial, mildew-resistant and soft foam rubber skin manufactured according to various external shapes of the mice.

2) Description of the Prior Art

The conventional computer mice have various external styles in different colors; basically, the front aspect has three finger-actuated buttons and the rear portion is an arch case body shaped to conform to the user's palm; the case bodies are made of rigid plastics; however, since the rigid plastics does not absorb the sweat, it might cause discomfort to the user who sweats easily; furthermore, the surface and the seam area of the case body tend to accumulate dirt so they need to be wiped or cleansed.

In view of the mentioned reasons, the inventor of the present invention designed this improved structure to not only solve the said shortcomings, but also achieve the effective functions of being innovative, aesthetic and comfortable; it possesses industrial utility and advancement; although the composition of the present invention is simple, it is original and practical.

### SUMMARY OF THE INVENTION

The present invention is to affix the surface of a computer mouse with a layer of antibacterial, mildew-resistant and soft foam rubber skin manufactured according to various external shapes of the mice; the layer is adhered to the upper surface layer or the lateral surface layer also of the mouse in the manner of forceful affixation or a simple peelable and replaceable method; the color of the foam rubber skin can be multiple to achieve the functions of being innovative, aesthetic, comfortable, anti-dust and antistatic; more especially, in the public area or the computer network shops, the soft foam rubber skin can be easily peeled off for replacement at anytime to achieve the innovative and sanitary effect.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a drawing of an exemplary embodiment of the computer mouse of the present invention.

FIG. 2 is a drawing of another exemplary embodiment of the present invention.

### DETAILED DESCRIPTION OF THE PREFERRED EMBODIMENTS

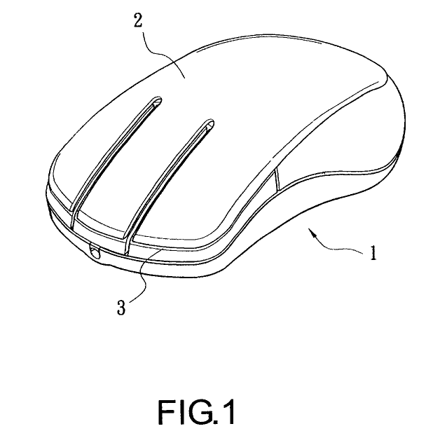

Referring to FIG. 1, the present invention comprises a computer mouse body (1) and a soft foam rubber skin (2); the soft foam rubber skin (2) can be manufactured according to various external shapes of the mice and affixed to the upper surface layers thereof; the foam rubber skin at the portion of the finger-actuated buttons is trimmed according to the shapes of the push buttons (3) in the manner of forceful affixation or a simple peelable and replaceable method.

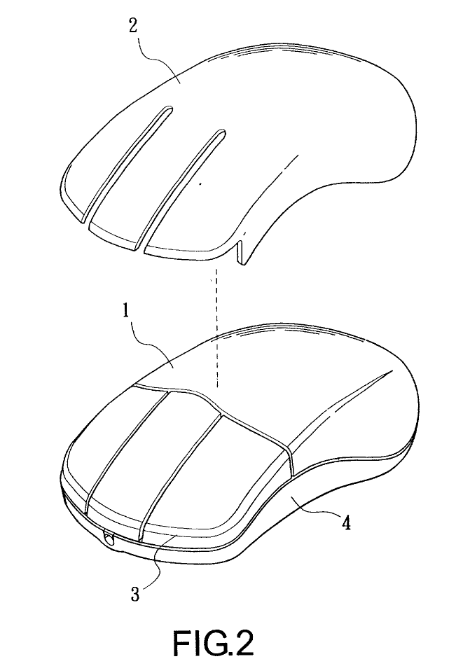

Referring to FIG. 2, the another exemplary embodiment of the present invention, it comprises a computer mouse (1) and a soft foam rubber skin (2); the soft rubber skin (2) is made according to various external shapes of the mice and affixed to the upper surface layers thereof; it is also expanded to the two lateral side portions (4) of the mouse body (1) permitting the user's thumb and pinkie to touch the soft foam rubber skin (2) without contacting the plastic case body; the adhesive manner can also be forceful affixation or a simple peelable and replaceable method.

It is of course to be understood that the embodiment described herein is merely illustrative of the principles of the invention and that a wide variety of modifications thereto may be effected by persons skilled in the art without departing from the spirit and scope of the invention as set forth in the following claims.

1. The present invention of a computer mouse with a hand-protecting cover relates to having the surface of the mouse affixed by a layer of antibacterial, mildew-resistant and soft foam rubber skin manufactured according to various external shapes of the mice; the layer is adhered to the upper surface layer of the mouse in a manner of forceful affixation

2. The present invention of a computer mouse with a hand-protecting cover according to claim 1, wherein the surface color of the foam rubber skin can be multiple and in printed patterns.

3. The present invention of a computer mouse with a hand-protecting cover according to claim 1, wherein the soft foam rubber skin is affixed to the upper surface layer of the mouse and expanded to two lateral side portions of the mouse body.

4. The present invention of a computer mouse with a hand-protecting cover according to claim 1, wherein, the soft foam rubber skin affixed at the finger-actuated button portion is trimmed according to the shape of the push button.

5. The present invention of a computer mouse with a hand-protecting cover according to claim 1, wherein the affixation manner can be a simple peelable and replaceable method.
